(19) United States
(12) Patent Application Publication
(10) Pub. No.: US 2018/0054650 A1
(43) Pub. Date: Feb. 22, 2018

(54) Interactive 360º VR Video Streaming

(71) Applicant: Visbit Inc., Sunnyvale, CA (US)

(72) Inventor: Changyin ZHOU, San Jose, CA (US)

(21) Appl. No.: 15/678,406

(22) Filed: Aug. 16, 2017

Related U.S. Application Data
(60) Provisional application No. 62/375,710, filed on Aug. 16, 2016.

(51) Int. Cl. H04N 21/44; H04N 21/858; H04N 21/482; G11B 27/00; G11B 20/10; H04N 21/422; H04N 21/81; H04N 21/45; H04N 21/231; H04N 21/262

(52) U.S. Cl. CPC H04N 21/44016; H04N 21/8586; H04N 21/4825; G11B 27/002; G11B 20/10527; G11B 2020/10768; H04N 21/816; H04N 21/4532; H04N 21/44004; H04N 21/23106; H04N 21/26258; H04N 21/42204

(57) ABSTRACT

The present disclosure relates to methods and systems for providing virtual reality video content. An example system may include a display and a sensor configured to detect a user input and a media server configured to execute instructions stored in memory so as to carry out operations. Operations include loading a nonlinear video structure. The nonlinear video structure includes a plurality of uniform resource identifiers. Each uniform resource identifier is associated with a respective video trunk. The nonlinear video structure includes an arrangement of respective video trunks coupled by at least one transition trunk. The operations include determining an initial playlist based on the nonlinear video structure, streaming the initial playlist from a media server via network, and rendering video frames to a display. The operations include, while loading the at least one transition trunk, receiving the user input and playing a next playlist based on the received user input.

### CROSS-REFERENCE TO RELATED APPLICATIONS

This application claims priority to U.S. Provisional Patent Application No. 62/375,710 filed Aug. 16, 2016, the contents of which are hereby incorporated by reference.

### BACKGROUND

Virtual reality (VR) 360° video content allows a user to turn his/her head around or change his/her eye gaze direction to view content from different directions, which yields an immersive experience. However, in such virtual environments, users are purely observers and have no impact on the linear story flow. This greatly limits the immersive experience.

Traditional video technologies offer some limited possibilities for non-linear storytelling. For example, such technologies may pause a video and show a menu at a predetermined transition/decision point. In such a scenario, the user may provide an input selection, which may determine the next video clip.

### SUMMARY

Systems and methods disclosed herein relate to structures for non-linear storytelling using 360° virtual reality (VR) video content. Such systems and methods may be additionally or alternatively applied to video content with an arbitrary field of view (e.g., 180° VR video content). Non-linear storytelling structures may incorporate various user interactions within a VR environment. As such, the systems and methods described herein may provide users with an ability to choose different virtual reality story paths dynamically and seamlessly.

In an aspect, a virtual reality system is provided. The virtual reality system includes a media server that hosts and serves media data via a network. The virtual reality system includes a sensor configured to detect a user input and a display. The virtual reality system also includes a media player configured to execute instructions stored in memory so as to carry out operations. The operations include loading a nonlinear video structure from a media server via a network. The nonlinear video structure includes a plurality of uniform resource identifiers. Each uniform resource identifier is associated with a respective video trunk. The nonlinear video structure includes an arrangement of respective video trunks coupled by at least one transition trunk. The operations also include determining an initial playlist based on the nonlinear video structure, streaming the initial playlist from the media server, and rendering video frames for displaying via the display. The operations further include, while loading the at least one transition trunk, receiving the user input and determining a next playlist based on the received user input. The operations also include streaming the next playlist from the media server.

In an aspect, a method is provided. The method includes loading a nonlinear video structure. The nonlinear video structure includes a plurality of uniform resource identifiers. Each uniform resource identifier is associated with a respective video trunk. The nonlinear video structure includes an arrangement of respective video trunks coupled by at least one transition trunk. The method includes determining an initial playlist based on the nonlinear video structure, streaming the initial playlist from a media server via network, and rendering video images associated with the initial playlist for displaying via a display. The method also includes, while loading the at least one transition trunk, receiving a user input via a user interface and determining a next playlist based on the received user input. The method yet further includes streaming the next playlist from the media server.

In an aspect, a method is provided. The method includes loading a nonlinear video structure. The nonlinear video structure includes a plurality of uniform resource identifiers. Each uniform resource identifier is associated with a respective video trunk. The nonlinear video structure includes an arrangement of respective video trunks coupled by at least one transition trunk. The method also includes determining an initial playlist based on the nonlinear video structure, streaming the initial playlist from a media server via a network, and rendering video images associated with the initial playlist for displaying via a display. The method yet further includes, when playback is within a predetermined amount of time from an end of a currently-playing stream, loading all video trunks corresponding with possible next playlists based on the non-linear video structure. The method also includes receiving a user input via a user interface and selecting a proper next playlist based on the received user input. The method yet further includes streaming the proper next playlist from the media server.

In an aspect, a system is provided. The system includes various means for carrying out the operations of the other respective aspects described herein.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1A illustrates a linear video storytelling representation, according to an example embodiment.

FIG. 1B illustrates a non-linear video storytelling representation, according to an example embodiment.

FIG. 1C illustrates a non-linear video storytelling representation, according to an example embodiment.

FIG. 2 illustrates a non-linear video storytelling representation, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

I. Videos with Linear Storytelling

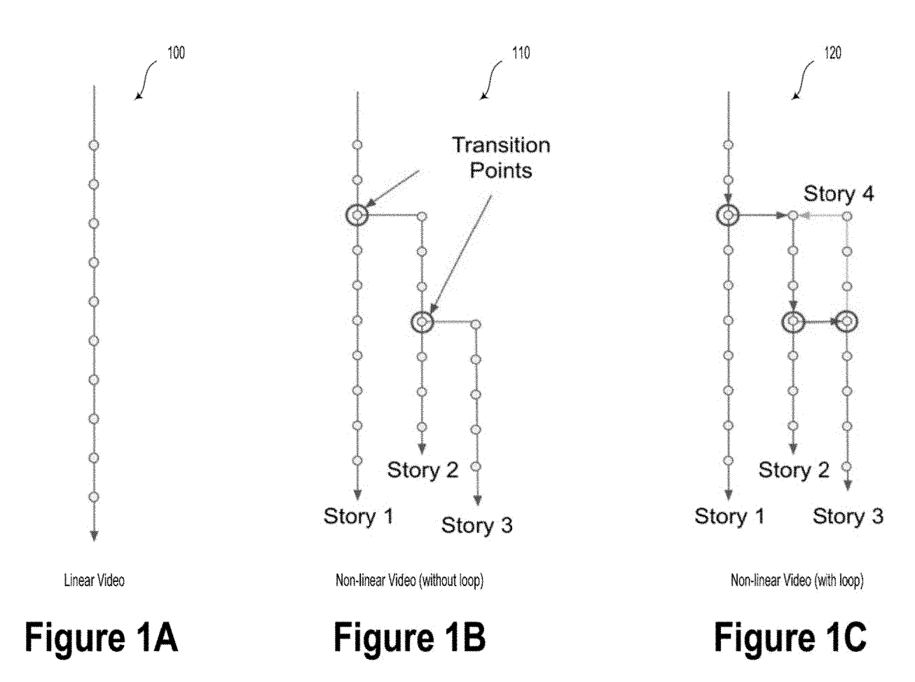

FIG. 1A illustrates a linear video storytelling representation 100, according to an example embodiment. A traditional video usually conveys a story in a linear fashion, as illustrated in FIG. 1A. Only one story flow exists and users have no control of the substantive flow of story, except perhaps to pause, fast forward, or reverse the story flow. For videos that include a linear story, streaming to a client viewer is straightforward. A video player on the client side device (e.g., a streaming device, a smart phone, a television, or a head-mountable device) need only to fetch (or prefetch) video data in a sequential manner from a media server. In an example embodiment, the video data may be initially buffered in memory to deal with network instability (e.g., due to variable data transmission rates). The video data may then be decoded into image frames, which may be rendered frames at appropriate times to provide smooth playback.

II. Videos with Non-Linear Storytelling

FIG. 1B illustrates a non-linear video storytelling representation 110, according to an example embodiment. In a non-linear video, the video may include a plurality of different story flows as shown in FIG. 1B. In an example embodiment, one or more story flows may branch from another story flow at a transition point. As such, each transition point may provide one or more possible story flows. In an example embodiment, a selected story flow may be selected from the possible story flows based on a predetermined user behavior or user behavioral analysis.

Although not illustrated in FIG. 1B, a plurality of non-linear story flows may converge into a single story flow. That is, a non-linear storytelling representation may include multiple story lines (during a first period of time), which may collapse or contract into a single story line (during a second period of time). Other combinations and arrangements of multiple story lines are possible and contemplated.

FIG. 1C illustrates a non-linear video storytelling representation 120, according to an example embodiment. In an example embodiment, a story flow may include one or more loops as illustrated in FIG. 1C.

### III. Nonlinear Video Representation

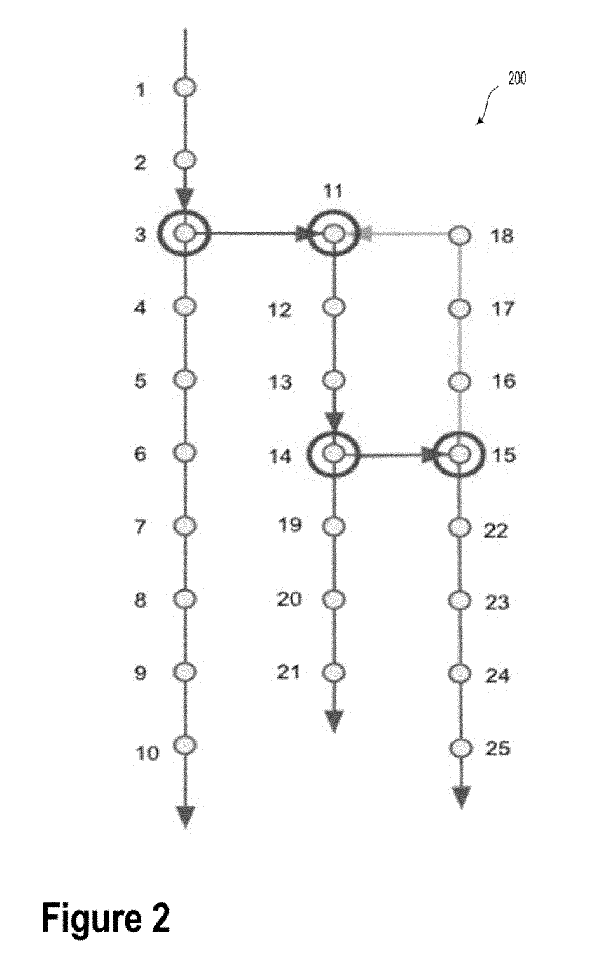

FIG. 2 illustrates a non-linear video storytelling representation 200, according to an example embodiment. The nonlinear video representation 200 may be provided via a media server and may include many video trunks (labeled 1-25 in FIG. 2). In one embodiment, information about nonlinear storytelling representation 200 may be stored in a descriptive file, such as an Extensible Markup Language (XML) file, a database file (e.g., a db file), a JavaScript Object Notation (JSON), or a text file. The nonlinear storytelling representation 200 may be further defined as follows:
1) Each video trunk is assigned a unique identifier, which could be a Uniform Resource Identifier (URI). In an example embodiment, the URI may be a unique string of characters used to identify a particular video trunk.
2) Each individual linear piece of the story flow is defined by a media playlist. For example, in FIG. 2, there will be eight playlists:
   a. Playlist 1 includes Trunk 1, 2, 3
   b. Playlist 2 includes Trunk 3, 4, 5, 6, 7, 8, 9, 10
   c. Playlist 3 includes Trunk 3, 11
   d. Playlist 4 includes Trunk 11, 12, 13, 14
   e. Playlist 5 includes Trunk 14, 19, 20, 21
   f. Playlist 6 includes Trunk 14, 15
   g. Playlist 7 includes Trunk 15, 16, 17, 18, 11
   h. Playlist 8 includes Trunk 15, 22, 23, 24, 25
3) The initial playlist is identified or set. As illustrated in FIG. 2, the initial playlist is Playlist 1.
4) A list of transition points and corresponding transitions based on one or more user inputs are defined. As illustrated in FIG. 2, the transition points are as follows:
   a) Trunk 3:
      i) If the user looks to the left at the start of Trunk 3, continue with Playlist 2.
      ii) Else, continue with Playlist 3.
   b) Trunk 11:
      i) Continue with Playlist 4.
   c) Trunk 14:
      i) If user looks to the left at the start of Trunk 14, continue with Playlist 5.
      ii) Else, continue with Playlist 6.
   d) Trunk 15:
      i) If user looks to the left at the start of Trunk 15, continue with Playlist 7.
      ii) Else, continue with Playlist 8.

In an example embodiment, the transition trunks (#3, #11, #14, #15) may be shared by multiple playlists. This sharing may provide for smooth transitions as switching between playlists may be performed while playing back the transition trunk. That is, a prior playlist need not play to completion before transition to a subsequent playlist. Rather, the prior and subsequent playlists may be synchronized via a global time clock, such as a video streaming presentation time stamp (PTS). Under such a scenario, the prior playlist may stop playing (even during playback of the transition trunk) once the subsequent playlist begins synchronized playback of the remaining portion of the transition trunk.

In another embodiment, the playlists need not include shared transition trunks. In such a scenario, a pause may be provided (or may be necessary) before switching to a new playlist. Additionally or alternatively, a device may pre-fetch trunks in all possible paths to provide a smoother transition.

In some embodiments, unneeded video trunks may be partially or completely deleted from memory when not needed (e.g., the user interaction leads to a different video trunk being selected). As such, by causing the media player to handle a small number of video trunks at any given time, computing resources may be conserved and utilized more efficiently.

In another embodiment, the video need not be cut into small (short time segment) trunks. Instead, each playlist above may include an individual (discrete) piece of video. Furthermore, which FIGS. 1B, 1C, and 2 illustrate “single branches” (e.g., a single prior playlist branching at a transition point to two subsequent playlists), a non-linear video storytelling representation could include any number of subsequent playlists that branch from a given transition point.

### IV. User Interactions for Nonlinear VR Videos

A. Implicit User Input

In an embodiment, users may provide one or more implicit inputs before and/or during playback of a transition point/video trunk. A determination of which subsequent playlist to play may be based on the implicit user input(s). In an example embodiment, an implicit input may be determined based on tracking where a user is looking (e.g., via head- and/or eye-tracking methods and systems) and other known information about the user. While the user is immersed in a virtual reality environment, a virtual reality application may be configured to track movements and/or an orientation of the user's head. By tracking a user's gaze and/or head position, the VR application may determine which story path (e.g., which subsequent playlist) should be selected.

For example, in a non-linear VR video that simulates driving on New York City streets, a user may approach a 3-way intersection. A road to the left may lead to the Financial District (e.g., Wall Street) and a road to the right may lead to the Brooklyn Bridge. A decision can be made automatically based on a user's historical behavior and/or preferences. For example, if the user has viewed primarily financial-related buildings in the past few minutes, then continue the video of a tour of the Financial District; otherwise, continue with a video of driving over the Brooklyn Bridge.

These decisions may also be made according to user profiles, which may be associated to a preexisting user account, generated upon first use, and adjusted based on user interactions. Decisions could additionally or alternatively be made based on anonymous user statistics gathered from other similar or related users.

Implicit user input may provide a better user experience because an optimal path is automatically chosen on behalf of the user and direct action is not needed in some or all cases.

B. Explicit User Input

In another embodiment, a user's explicit input may be used to determine a subsequent playlist for playback. Many different types of explicit user inputs are contemplated, some of which may include:
1. User head/eye orientations (e.g., indicative of objects/text/images a user may be looking at).
2. Speech commands (e.g., “Turn right” or “Drive over the Brooklyn Bridge”).
3. Controller inputs (e.g., joystick, button, mouse, keyboard, multi-function controller).
4. Inertial Measurement Unit (IMU) patterns (e.g., Head Up, Head Down or Head Left, Head Right).
5. Or any mixture of inputs above (e.g., Head Up, Head Up, Head Down, Head Down, Head Left, Head Right, Head Left, Head Right, B Button, A Button, Start Button).

In an embodiment, a choice may be made and/or recognized while a video trunk corresponding with a transition point continues playing. In another embodiment, video playback may be paused until a choice is made.

While embodiments herein may utilize implicit or explicit user interactions to determine a next video trunk to play, some embodiments may utilize a hybrid system of user interactions. For example, a machine learning algorithm could include determining an implicit user interaction from which the next video trunk may be determined. Subsequently, an explicit user interaction may be received, which may provide “training” to the system. Over time, and/or over a series of implicit and explicit user interactions, the system and method may become more attuned to a given user or decision-making scenario, which may provide a more intuitive, user-friendly, user experience.

C. Choice Hints to Users

Optionally, when a user is approaching a transition point, a “hint” or another type of indication may be provided to the user. In one embodiment, one or more visual indicators may be displayed on a user display. For example, in the VR driving scenario, directional arrows may be superimposed over the video images at the 3-way intersection to indicate possible directions of travel or choices. Alternatively or additionally, a menu may be displayed. Note that the video may be, but need not be, paused while such visual indications are being provided.

In another embodiment, such “hints” may take the form of voice prompts, text, haptic feedback, audio chime, dimmed/brightened display, defocused/hazy display, etc.

D. Feedback to User Input

Furthermore, feedback may optionally be provided to the user when a subsequent video stream is selected based on user input. Possible user feedback may include visual cues, audio cues, text display, haptic feedback, or another form of feedback.

### V. Techniques to Smoothly Stream Nonlinear VR Videos

Note that the present disclosure relates to interactive, streaming nonlinear VR video content. Such content is distinct from traditional video games, where all contents are pre-stored and/or rendered locally. In the present disclosure, video streams for each possible branch from a given transition point may be pre-fetched prior to the transition point. Furthermore, unneeded video content may be deleted from memory based on user interactions that select other video content for rendering/display.

In an example embodiment, a media server may be hosted on one or more cloud computing networks. In such a scenario, the media server may host all playlists, video trunks, and video structure metadata. The media server may also serve these data to a client media player via network based on a client request. The client media player may exist as software, firmware, and/or hardware on mobile phones or other virtual reality client devices. The client media player may receive information indicative of a user input or user behavior. That is, the client media player may detect and respond to user behaviors. In an example embodiment, the client media player may request proper data based on the user input or user behavior. The methods described herein may be carried out fully, or in part, by the client media player.

In one embodiment, the non-linear video stream representation may include shared video trunks that correspond with the transition points as illustrated in FIGS. 1B and 1C. In an effort to provide smooth video transitions from a prior video stream to a subsequent video stream, the following process may be utilized:

1. Pre-load the nonlinear video structure.

2. Start to stream the initial playlist.

3. Whenever a transition trunk starts to load, determine the next playlist, based on user interactions.

4. Continue to stream the next playlist.

5. Go to Step 3.

In another embodiment, there is no shared transition trunk between connecting playlists, or there are very few shared transition trunks. In such scenarios, the following process may be utilized:

1. Pre-load the nonlinear video structure.

2. Start to stream the initial playlist.

3. When streaming is within a predetermined time to the end of stream (say within m seconds), start to pre-load trunks from each of the possible next playlists.

4. When user input is determined, select the proper next playlist, and discard trunk information for all other playlists.

5. Continue to stream the next playlist.

6. Go to Step 3.

It is understood that the systems and methods described herein may be applied to augmented reality (AR) scenarios as well as VR scenarios. That is, the video images presently described may be superimposed over a live direct or indirect view of a physical, real-world environment. Furthermore, although embodiments herein describe 360° virtual reality video content, it is understood that video content corresponding to smaller portions of a viewing sphere may be used within the context of the present disclosure.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A virtual reality system comprising:
a sensor configured to detect a user input;
a media server that hosts and serves media data via a network;
a display;
a media player configured to execute instructions stored in memory so as to carry out operations, the operations comprising:
loading a nonlinear video structure, wherein the nonlinear video structure comprises a plurality of uniform resource identifiers, wherein each uniform resource identifier is associated with a respective video trunk, wherein the nonlinear video structure comprises an arrangement of respective video trunks coupled by at least one transition trunk;
determining an initial playlist based on the nonlinear video structure;
streaming video frames associated with the initial playlist from the media server;
rendering the video frames for display via the display;
while loading the at least one transition trunk, receiving the user input and determining a next playlist based on the received user input; and
streaming video frames associated with the next playlist from the media server.

2. The virtual reality system of claim 1, wherein the sensor comprises at least one of: an inertial measurement unit, a button, an eye-tracking sensor, or a head-tracking sensor.

3. The virtual reality system of claim 1, wherein the display is incorporated into a head-mountable device.

4. The virtual reality system of claim 1, wherein the nonlinear video structure is embodied in a descriptive file, wherein the descriptive file comprises an Extensible Markup Language (XML) file, a database file, a JavaScript Object Notation (JSON), or a text file.

5. The virtual reality system of claim 1, wherein the user input comprises an implicit user interaction, wherein the implicit user interaction is determined based on historical user preference or historical user behavior.

6. The virtual reality system of claim 1, wherein the user input comprises an explicit user interaction, wherein the explicit user interaction comprises at least one of: a button press, a head movement, an eye movement, or a controller movement.

7. A method comprising:
loading a nonlinear video structure, wherein the nonlinear video structure comprises a plurality of uniform resource identifiers, wherein each uniform resource identifier is associated with a respective video trunk, wherein the nonlinear video structure comprises an arrangement of respective video trunks coupled by at least one transition trunk;
determining an initial playlist based on the nonlinear video structure;
streaming video frames associated with the initial playlist from a media server via a network;
rendering the video frames for display via a display;
while loading the at least one transition trunk, receiving a user input via a user interface and determining a next playlist based on the received user input; and
streaming video frames associated with the next playlist from the media server.

8. The method of claim 7, wherein the user interface comprises at least one of: an inertial measurement unit, a button, an eye-tracking sensor, or a head-tracking sensor.

9. The method of claim 7, wherein the display is incorporated into a head-mountable device.

10. The method of claim 7, wherein the nonlinear video structure is embodied in a descriptive file, wherein the descriptive file comprises an Extensible Markup Language (XML) file, a database file, a JavaScript Object Notation (JSON), or a text file.

11. The method of claim 7, wherein the user input comprises an implicit user interaction, wherein the implicit user interaction is determined based on historical user preference or historical user behavior.

12. The method of claim 7, wherein the user input comprises an explicit user interaction, wherein the explicit user interaction comprises at least one of: a button press, a head movement, an eye movement, or a controller movement.

13. The method of claim 7, further comprising, while loading the at least one transition trunk, providing an indicator, wherein the indicator comprises at least one of: visual information, a voice prompt, text, haptic feedback, audio chime, a dimmed/brightened display, or a defocused/hazy display.

14. A method comprising:
loading a nonlinear video structure, wherein the nonlinear video structure comprises a plurality of uniform resource identifiers, wherein each uniform resource identifier is associated with a respective video trunk, wherein the nonlinear video structure comprises an arrangement of respective video trunks coupled by at least one transition trunk;
determining an initial playlist based on the nonlinear video structure;
streaming video frames associated with the initial playlist from a media server via a network;
rendering video frames for display via a display;
when playback is within a predetermined amount of time from an end of a currently-playing stream, loading all video trunks corresponding with possible next playlists based on the nonlinear video structure;
receiving a user input via a user interface;
selecting a proper next playlist based on the received user input; and
streaming video frames associated with the proper next playlist from the media server.

15. The method of claim 14, wherein the user interface comprises at least one of: an inertial measurement unit, a button, an eye-tracking sensor, or a head-tracking sensor.

16. The method of claim 14, wherein the display is incorporated into a head-mountable device.

17. The method of claim 14, wherein the nonlinear video structure is embodied in a descriptive file, wherein the descriptive file comprises an Extensible Markup Language (XML) file, a database file, a JavaScript Object Notation (JSON), or a text file.

18. The method of claim 14, wherein the user input comprises an implicit user interaction, wherein the implicit user interaction is determined based on historical user preference or historical user behavior.

19. The method of claim 14, wherein the user input comprises an explicit user interaction, wherein the explicit user interaction comprises at least one of: a button press, a head movement, an eye movement, or a controller movement.

20. The method of claim 14, further comprising, when playback is within a predetermined amount of time from an end of a currently-playing stream, providing an indicator, wherein the indicator comprises at least one of: visual information, a voice prompt, text, haptic feedback, audio chime, a dimmed/brightened display, or a defocused/hazy display.
